(19) United States
(12) Patent Application Publication
(10) Pub. No.: US 2026/0029674 A1
(43) Pub. Date: Jan. 29, 2026

(54) POLARIZER PROTECTION FILM, POLARIZING PLATE, AND LIQUID CRYSTAL PANEL

(71) Applicant: KANEKA CORPORATION, Osaka (JP)

(72) Inventor: Naoto Kataoka, Osaka (JP)

(73) Assignee: KANEKA CORPORATION, Osaka (JP)

(21) Appl. No.: 19/342,433

(22) Filed: Sep. 26, 2025

Related U.S. Application Data
(63) Continuation-in-part of application No. PCT/JP2024/012147, filed on Mar. 27, 2024.

(30) Foreign Application Priority Data
Mar. 30, 2023 (JP) 2023-056577

(51) Int. Cl. G02F 1/1335; G02B 1/14; G02B 5/30

(52) U.S. Cl. CPC G02F 1/133528; G02B 1/14; G02B 5/3025

(57) ABSTRACT

A polarizer protection film including an acrylic resin composition is provided. The polarizer protection film has a retardation Rth in the thickness direction at a wavelength of 590 nm of −15.0 nm to less than 0.0 nm. The acrylic resin composition includes an acrylic resin having a ring structure in the main chain thereof, has a glass transition temperature of 120° C. or higher, and has a birefringence development Δnxy of −1.0×10⁻³ to −0.1×10⁻³.

### TECHNICAL FIELD

One or more embodiments of the present invention relate to a polarizer protective film, a polarizing plate, and a liquid crystal panel.

### BACKGROUND

Acrylic resins have excellent transparency, color tone, appearance, heat resistance, and processability, and thus have been applied to, for example, polarizer protective films (see, for example, Patent Document 1). Here, a polarizer protective film is applied to a liquid crystal panel by being bonded to both surfaces of a polarizer to form a polarizing plate, and then being disposed on both surfaces of a liquid crystal cell.

On the other hand, a liquid crystal panel of IPS system may be used in applications such as a liquid crystal television because of its wide viewing angle and excellent color reproducibility.

### PATENT DOCUMENT

Patent Document 1: Japanese Unexamined Patent Application, Publication No. 2017-25333

However, when a polarizer protective film containing an acrylic resin is applied to an IPS-type liquid crystal panel, a slight yellow tint occurs in some cases, when a liquid crystal panel displaying black is viewed from an oblique direction. On the other hand, when the color tone is optically compensated by the retardation of the polarizer protective film, if there is a variation in the in-plane retardation of the polarizer protective film, unevenness may occur in displaying the liquid crystal panel.

### SUMMARY

A polarizer protective film capable of achieving both uniformity of in-plane retardation and reduction in yellowness index when viewed from an oblique direction of a liquid crystal panel is provided.
[1] A polarizer protective film including an acrylic resin composition, in which a thickness direction retardation Rth at a wavelength of 590 nm is −15.0 nm or more and less than 0.0 nm; the acrylic resin composition includes an acrylic resin having a ring structure in a main chain; the acrylic resin composition has a glass transition temperature of 120° C. or higher; and the acrylic resin composition has a birefringence developability Δnxy of −1.0×10⁻³ or more and −1.0×10⁻⁴ or less.
[2] The polarizer protective film as described in (1), in which the acrylic resin having a ring structure in the main chain has a constitutional unit including at least one ring structure selected from the group consisting of a glutarimide ring, a lactone ring, a maleic anhydride ring, a maleimide ring, and a glutaric anhydride ring in the main chain.
[3] The polarizer protective film as described in [2], in which the acrylic resin having a ring structure in the main chain has a constitutional unit represented by the following formula (1):

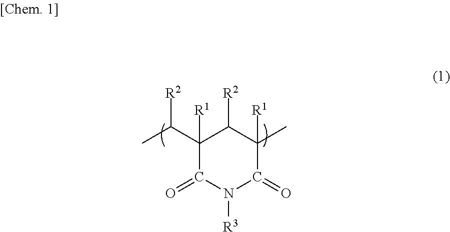

in which R¹ and R² are each independently a hydrogen atom or an alkyl group having 1 or more and 8 or less carbon atoms, and R³ is a hydrogen atom, an alkyl group having 1 or more and 18 or less carbon atoms, or a cycloalkyl group having 3 or more and 12 or less carbon atoms.
[4] The polarizer protective film as described in any one of [1] to [3], in which a content of a constitutional unit derived from aromatic vinyl is 0% by weight or more and 8% by weight or less.
[5] The polarizer protective film as described in [4], in which the content of a constitutional unit derived from styrene is 0% by weight or more and 8% by weight or less.
[6] The polarizer protective film as described in any one of [1] to [5], in which the acrylic resin composition further includes poly methyl methacrylate or a methyl methacrylate-styrene copolymer.
[7] The polarizer protective film as described in any one of [1] to [6], in which the acrylic resin composition has a 1% weight reduction temperature of 300° C. or higher. [8] The polarizer protective film as described in any one of [1] to [7], in which the polarizer protective film does not contain an ultraviolet absorber.
[9] The polarizer protective film as described in any one of [1] to [8], in which the polarizer protective film is a biaxially stretched film.
[10] The polarizer protective film as described in any one of [1] to [9], in which a yellowness index is 0.01 or more and 5.00 or less.
[11] The polarizer protective film as described in any one of [1] to [10], in which an absorbance at a wavelength of 380 nm is 0.01 or more and 1.00 or less.
[12] The polarizer protective film as described in any one of [1] to [11], in which an absolute value of an Nz coefficient is 0.1 or more and 30.0 or less; a ratio Rth(447)/Rth(548) of a thickness direction retardation Rth(447) at a wavelength of 447 nm to a thickness direction retardation Rth(548) at a wavelength of 548 nm is 0.50 or more and 1.10 or less; and a ratio Rth(628)/Rth(548) of a thickness direction retardation Rth(628) at a wavelength of 628 nm to a thickness direction retardation Rth(548) at a wavelength of 548 nm is 0.50 or more and 2.00 or less.
[13] The polarizer protective film as described in any one of [1] to [12], in which the acrylic resin composition includes the acrylic resin having a ring structure in a main chain, as a main component.
[14] The polarizer protective film as described in any one of [1] to [13], in which the acrylic resin composition is free of core-shell rubber particles.
[15] The polarizer protective film as described in any one of [1] to [14], wherein an internal haze is 1.0% or less.
[16] A polarizer protective film including an acrylic resin composition, in which an average value of in-plane retardations Re is greater than 0.0 nm and 0.7 nm or less, a thickness-direction retardation Rth at a wavelength 590 nm is −15.0 nm or more and less than 0.0 nm, the acrylic resin composition includes an acrylic resin having a ring structure in a main chain, and a glass transition temperature is 120° C. or higher.
[17] The polarizer protective film as described in [16], in which the thickness-direction retardation Rth at a wavelength 590 nm is −13.0 nm or more and −2.5 nm or less.
[18] A polarizer protective film including an acrylic resin composition, in which the acrylic resin composition contains an acrylic resin having a ring structure in a main chain, a glass transition temperature is 120° C. or higher, a thickness direction retardation at a wavelength 590 nm is −15.0 nm or more and less than 0.0 nm, and a standard deviation of in-plane retardations Re is less than 0.2.
[19] A polarizing plate including the polarizer protective film as described in any one of [1] to [18].
[20] A liquid crystal panel including the polarizing plate as described in.

According to one or more embodiments of the present invention, it is possible to provide a polarizer protective film capable of achieving both uniformity of in-plane retardation and reduction in the yellowness index when viewed from an oblique direction of a liquid crystal panel.

### DETAILED DESCRIPTION

Hereinafter, one or more embodiments of the present invention will be described.

### Features of First Aspect of Present Embodiment

### (Polarizer Protective Film)

The polarizer protective film of the present embodiment includes an acrylic resin composition.

The thickness direction retardation Rth of the polarizer protective film of the present embodiment at a wavelength of 590 nm may be −15.0 nm or more and less than 0.0 nm, −13.0 nm or more and −2.5 nm or less, −10.0 nm or more and −2.5 nm or less, −10.0 nm or more and −5.0 nm or less, or −10.0 nm or more and −7.0 nm or less. When Rth is −15.0 nm or more and less than 0.0 nm, the yellowness index of the liquid crystal panel when viewed from an oblique direction is reduced. At this time, the polarizer protective film of the present embodiment may have a yellowness index of 50 or less when viewed from an oblique direction of the liquid crystal panel.

The average value of the in-plane retardation Re of the polarizer protective film of the present embodiment may be greater than 0.0 nm and 0.7 nm or less, or 0.6 nm or less. When the average value of Re is 0.7 nm or less, uniformity of the in-plane retardation Re is improved. At this time, the polarizer protective film of the present embodiment may have a standard deviation of the in-plane retardation Re of less than 0.2.

Re and Rth are calculated by the following formulae:

$$\begin{matrix}R e = ( n x - n y ) \times d and \\ Rth = [ ( n x + ny ) / 2 - n z ] \times d .\end{matrix}$$

Here, nx, ny, and nz are refractive indices in the X-axis direction, the Y-axis direction, and the Z-axis direction, respectively, where the MD direction is the X-axis, the TD direction is the Y-axis, and the thickness direction of the film is the Z-axis. In addition, d is the film thickness.

### Features of Second Aspect of Present Embodiment

### (Polarizer Protective Film)

The polarizer protective film of the present embodiment includes an acrylic resin composition.

An average value of in-plane retardations Re of the polarizer protective film of the present embodiment may be greater than 0.0 nm and 0.7 nm or less, or 0.6 nm or less. When the average value of Re is 0.7 nm or less, uniformity of the in-plane retardation is improved. At this time, the polarizer protective film of the present embodiment may have a standard deviation of the in-plane retardations Re of less than 0.2.

The thickness direction retardation Rth of the polarizer protective film of the present embodiment may be −15.0 nm or more and less than 0.0 nm, −13.0 nm or more and −2.5 nm or less, −10.0 nm or more and −2.5 nm or less, −10.0 nm or more and −5.0 nm or less, or −10.0 nm or more and −7.0 nm or less. When Rth is −15.0 nm or more and less than 0.0 nm, a yellowness index when viewed from an oblique direction of the liquid crystal panel is reduced. At this time, the polarizer protective film of the present embodiment may have a yellowness index of 50 or less when viewed from an oblique direction of the liquid crystal panel.

### Features of Third Aspect of Present Embodiment

### (Polarizer Protective Film)

The polarizer protective film of the present embodiment includes an acrylic resin composition.

The thickness direction retardation Rth of the polarizer protective film of the present embodiment may be −15.0 nm or more and less than 0.0 nm, −13.0 nm or more and −2.5 nm or less, −10.0 nm or more and −2.5 nm or less, −10.0 nm or more and −5.0 nm or less, or −10.0 nm or more and −7.0 nm or less. When Rth is −15.0 nm or more and less than 0.0 nm, the yellowness index when viewed from an oblique direction of the liquid crystal panel is reduced. At this time, the polarizer protective film of the present embodiment may have a yellowness index of 50 or less when viewed from an oblique direction of the liquid crystal panel.

The standard deviation of in-plane retardations Re of the polarizer protective film of the present embodiment is less than 0.2. When the standard deviation of Re is less than 0.2, the uniformity of the in-plane retardation is improved.

### Common Features of First Aspect, Second Aspect, and Third Aspect of Present Embodiment

The yellowness index of the polarizer protective film of the present embodiment may be 0.01 or more and 5.00 or less, or 0.1 or more and 2.0 or less. When the yellowness index of the polarizer protective film of the present embodiment is 5.00 or less, the polarizer protective film of the present embodiment is less colored and has less influence on the color rendering properties of the display.

The absorbance of the polarizer protective film of the present embodiment at a wavelength of 380 nm may be 0.01 or more and 1.00 or less, or 0.10 or more and 0.80 or less. When the absorbance of the polarizer protective film of the present embodiment at a wavelength of 380 nm is 1.00 or less, the polarizer protective film of the present embodiment does not substantially contain an ultraviolet absorber.

The absolute value of the Nz coefficient of the polarizer protective film of the present embodiment may be 0.1 or more and 30.0 or less. When the absolute value of the Nz coefficient of the polarizer protective film of the present embodiment is 0.1 or more and 30.0 or less, the yellowness index when viewed from an oblique direction of the liquid crystal panel is reduced.

The ratio Rth(447)/Rth(548) of the thickness direction retardation Rth(447) at a wavelength of 447 nm to the thickness direction retardation Rth(548) at a wavelength of 548 nm of the polarizer protective film of the present embodiment may be 0.50 or more and 1.10 or less, 0.50 or more and 1.09 or less, or 0.80 or more and 1.08 or less. When Rth(447)/Rth(548) of the polarizer protective film of the present embodiment is 0.50 or more and 1.10 or less, the yellowness index when viewed from an oblique direction of the liquid crystal panel is reduced.

The ratio Rth(628)/Rth(548) of the thickness direction retardation Rth(628) at a wavelength of 628 nm to the thickness direction retardation Rth(548) at a wavelength of 548 nm of the polarizer protective film of the present embodiment may be 0.50 or more and 2.00 or less, or 0.7 or more and 1.5 or less. When Rth(628)/Rth(548) of the polarizer protective film of the present embodiment is 0.50 or more and 2.00 or less, the yellowness index when viewed from an oblique direction of the liquid crystal panel is reduced.

The photoelastic coefficient of the polarizer protective film of the present embodiment may be −10×10⁻¹² Pa⁻¹ or more and 10×10⁻¹² Pa⁻¹ or less, −5.5×10⁻¹² Pa⁻¹ or more and 5.5×10⁻¹² Pa⁻¹ or less, or −4.5×10⁻¹² Pa⁻¹ or more and 4.5×10⁻¹² Pa⁻¹ or less. When the photoelastic coefficient of the polarizer protective film of the present embodiment is −10×10⁻¹² Pa⁻¹ or more and 10×10⁻¹² Pa⁻¹ or less, color unevenness is less likely to occur in the polarizer protective film of the present embodiment, and the tendency becomes remarkable particularly in a high-temperature and high-humidity environment.

The inner haze of the polarizer protective film of the present embodiment may be 1.0% or less, 0.7% or less, 0.5% or less, or 0.3% or less. When the inner haze of the polarizer protective film of the present embodiment is 1.0% or less, quality when mounted in the liquid crystal panel is improved.

From the viewpoint of transparency, the haze of the polarizer protective film of the present embodiment may be 2.0% or less, 1.0% or less, or 0.5% or less.

### (Acrylic Resin Compositions)

The acrylic resin composition includes an acrylic resin having a ring structure in a main chain. The glass transition temperature of the acrylic resin composition may be 120° C. or higher, higher than 120° C., 121° C. or higher, or 122° C. or higher. When the glass transition temperature of the acrylic resin composition is lower than 120° C., orientation relaxation proceeds under a high-temperature and high-humidity environment, and the stability of the retardation may decrease. The glass transition temperature of the acrylic resin composition is, for example, 160° C. or lower.

The acrylic composition may include an acrylic resin having a ring structure in a main chain, as a main component. In the scope of the present specification and the claims, the main component means that the content is 50% by weight. Further, the acrylic resin composition may include core-shell rubber particles.

In the present specification and the claims, the acrylic resin means a polymer of a monomer having an acryloyl group and/or a monomer having a methacryloyl group. At this time, the acrylic resin may be either a homopolymer or a copolymer. When the acrylic resin is a copolymer, the acrylic resin may be a copolymer of a monomer having no acryloyl group or methacryloyl group.

The birefringence developability Δnxy of the acrylic resin composition may be −1.0×10⁻³ or more and −0.1×10⁻³ or less, −0.8×10⁻³ or more and −0.25×10⁻³ or less, −0.8×10⁻³ or more and −0.20×10⁻³ or less, or −0.8×10⁻³ or more and −0.12×10⁻³ or less. When Δnxy is −1.0×10⁻³ or more, a desired thickness direction retardation is likely to be exhibited when subjected to biaxial stretching, and when Δnxy is −0.1×10⁻³ or less, in-plane retardation is likely to be uniform when subjected to biaxial stretching.

In the present specification and the claims, the birefringence developability Δnxy of the acrylic resin composition means birefringence that is expressed when a film of an acrylic resin composition in an unstretched state is subjected to free-end uniaxial stretching at a temperature higher than the glass transition temperature of the acrylic resin composition by 5° C. so that the stretching ratio in the longitudinal direction (lengthwise direction) becomes twice.

Here, Δnxy is calculated by the following formula:

$$Δ nxy = nx - ny = R e / d .$$

Here, nx and ny are refractive indexes in the X-axis direction and the Y-axis direction, respectively, where the MD direction is the X-axis, the TD direction is the Y-axis, and the thickness direction of the film is the Z-axis, respectively. In addition, Re is the in-plane retardation of the film, and d is the film thickness.

The acrylic resin composition may further include, for example, poly methyl methacrylate or a methyl methacrylate-styrene copolymer. The acrylic resin contained in the acrylic resin composition may not have a constitutional unit derived from aromatic vinyl.

The content of the constitutional unit derived from aromatic vinyl (for example, styrene) in the acrylic resin composition may be 0% by weight or more and 8% by weight or less, 0.5% by weight or more and 5% by weight or less, 0.5% by weight or more and 3% by weight or less, 0.5% by weight or more and 2.5% by weight or less, or 1.0% by weight or more and 2.5% by weight or less. When the content of the constitutional unit derived from aromatic vinyl (for example, styrene) in the acrylic resin composition is 8% by weight or less, the uniformity of the in-plane retardation of the polarizer protective film of the present embodiment is improved.

The acrylic resin composition may further contain an additive. Examples of the additive include, but are not particularly limited to, antioxidants, heat stabilizers, light stabilizers, ultraviolet absorbers, specific wavelength absorbers or specific wavelength absorbing dyes for the purpose of cutting blue light, light resistance stabilizers such as radical scavengers, retardation adjusters, catalysts, plasticizers, lubricants, antistatic agents, coloring agents, shrinkage inhibitors, antibacterial and deodorizing agents, fluorescent brighteners, and compatibilizers, and two or more of the above may be used in combination.

The 1% weight reduction temperature of the acrylic resin composition may be 300° C. or higher, 302° C. or higher, or 305° C. or higher. When the 1% weight reduction temperature of the acrylic resin composition is 300° C. or higher, contamination of the cooling rolls during production of a raw film is suppressed, and the film formability of the raw film is improved. The 18 weight reduction temperature of the raw film is, for example, 380° C. or lower.

The weight average molecular weight of the acrylic resin composition may be 50,000 or more and 200,000 or less, or 90,000 or more and 150,000 or less. When the weight average molecular weight of the acrylic resin composition is 50,000 or more, the mechanical properties of the molded article of the acrylic resin composition tend to be improved, and when the weight average molecular weight of the acrylic resin composition is 200,000 or less, the moldability of the acrylic resin composition tends to be improved.

The ratio (polydispersity) of the weight average molecular weight to the number average molecular weight of the acrylic resin composition may be 1.5 or more and 2.5 or less, or 1.5 or more and 2.2 or less. When the polydispersity of the acrylic resin composition is 1.5 or more, the flowability of the acrylic resin composition tends to be improved to facilitate molding, and when the polydispersity of the acrylic resin composition is 2.5 or less, the mechanical properties such as impact resistance, toughness, and bending resistance of the molded article of the acrylic resin composition tend to be improved.

The number average molecular weight and the weight average molecular weight of the acrylic resin composition are values in terms of standard polystyrene measured by gel permeation chromatography (GPC). The number average molecular weight and the weight average molecular weight of the acrylic resin composition can be controlled by the types and amounts used of the polymerization initiator and the chain transfer agent used in synthesizing the acrylic resin.

The polarizer protective film of the present embodiment can be bonded to a polarizer to form a polarizing plate. The polarizer is not particularly limited, and a known polarizer can be used. The polarizing plate can be combined with a liquid crystal cell to form a liquid crystal panel. In this case, it may be preferable to use an IPS liquid crystal cell having a wide viewing angle. In addition, when the polarizer protective film of the present embodiment is disposed on the side facing the liquid crystal cell, the polarizer protective film may not contain an ultraviolet absorber or may not substantially contain an ultraviolet absorber.

### (Acrylic Resin Having Ring Structure in Main Chain)

The acrylic resin having a ring structure in the main chain (hereinafter referred to as an acrylic resin) may have a constitutional unit containing one or more ring structures selected from the group consisting of a glutarimide ring, a lactone ring, a maleic anhydride ring, a maleimide ring, and a glutaric anhydride ring in the main chain.

The constitutional unit containing a glutarimide ring in the main chain is represented by, for example, the following formula (1):

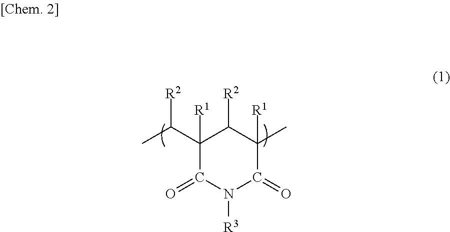

in which R¹ and R² are each independently a hydrogen atom or an alkyl group having 1 or more and 8 or less carbon atoms, and R³ is a hydrogen atom, an alkyl group having 1 or more and 18 or less carbon atoms, or a cycloalkyl group having 3 or more and 12 or less carbon atoms.

The acrylic resin having the constitutional unit represented by the formula (1) can be produced by a known method. Hereinafter, an example of a method for producing an acrylic resin having a constitutional unit represented by the formula (1) will be described.

First, using a twin-screw extruder with a die at the outlet, the methyl methacrylate resin is melted and then imidized, and a strand is extruded from the die. Next, the strand is cooled using a water bath, and then pelletized using a pelletizer to obtain an imidized methyl methacrylate resin. Next, the imidized methyl methacrylate resin is melted using a twin-screw extruder equipped with a die at the outlet, and then esterified, and a strand is extruded from the die. Next, the strand is cooled using a water bath, and then pelletized using a pelletizer to obtain an acrylic resin having a constitutional unit represented by the formula (1).

Examples of the imidizing agent include ammonia and a primary amine represented by the following formula (2). Among these, monomethylamine may be preferable.

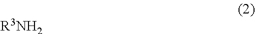

in which R³ is as defined in the formula (1).

Examples of the esterifying agent include dimethyl carbonate, 2,2-dimethoxypropane, dimethyl sulfoxide, triethyl orthoformate, trimethyl orthoacetate, trimethyl orthoformate, diphenyl carbonate, dimethyl sulfate, methyl toluene sulfonate, methyl trifluoromethyl sulfonate, methyl acetate, methanol, ethanol, methyl isocyanate, p-chlorophenyl isocyanate, dimethyl carbodiimide, dimethyl-t-butylsilyl chloride, isopropenyl acetate, dimethylurea, tetramethylammonium hydroxide, dimethyldiethoxysilane, tetra-n-butoxysilane, dimethyl (trimethylsilane)phosphite, trimethylphosphite, trimethylphosphate, tricresylphosphate, diazomethane, ethylene oxide, propylene oxide, cyclohexene oxide, 2-ethylhexylglycidyl ether, phenylglycidyl ether, and benzylglycidyl ether. Among these, dimethyl carbonate may be preferable.

The content of the constitutional unit containing a ring structure in the main chain in the acrylic resin may be 1% by weight or more and 80% by weight or less. The glass transition temperature of the acrylic resin may be 120° C. or higher and 160° C. or lower.

The acrylic resin may further have a constitutional unit derived from a (meth)acrylic acid ester.

Examples of the (meth)acrylic acid ester include alkyl (meth)acrylates such as methyl (meth)acrylate, ethyl (meth)acrylate, n-propyl (meth)acrylate, n-butyl (meth)acrylate, isobutyl (meth)acrylate, etc.; aryl (meth)acrylates, such as phenyl (meth)acrylate; aralkyl (meth)acrylates, such as benzyl (meth)acrylate; cycloalkyl (meth)acrylates such as cyclohexyl (meth)acrylate, and two or more thereof may be used in combination. Among these, alkyl methacrylates may be preferable, and methyl methacrylate may be particularly preferable.

The content of the constitutional unit derived from an alkyl methacrylate in the acrylic resin may be 50% by weight or more, 75% by weight or more, or 90% by weight or more.

The content of the constitutional unit derived from an acrylic acid ester in the acrylic resin may be less than 1% by weight, less than 0.5% by weight, or less than 0.3% by weight.

The acrylic resin may further have a constitutional unit derived from another monomer. The other monomer is not particularly limited, and examples thereof include aromatic monomers such as styrene, methylstyrene, etc.; and nitrile monomers such as acrylonitrile, methacrylonitrile, etc.

(Method for producing Polarizer Protective Films)

The polarizer protective film of the present embodiment can be produced using a known method. Hereinafter, an example of a method for producing the polarizer protective film of the present embodiment will be described.

First, using an extruder equipped with a die at the outlet, an acrylic resin is kneaded together with a methyl methacrylate-styrene copolymer as necessary, and then a strand is extruded from the die. Next, the strand is cooled using a water bath, and then pelletized using a pelletizer to obtain an acrylic resin composition. Next, the acrylic resin composition is melted by using an extruder having a T-die at the outlet, and then a sheet is extruded from the T-die and cooled by a cooling roll to obtain a raw film. Next, the raw film is biaxially stretched to obtain the polarizer protective film of the present embodiment. At this time, the biaxial stretching may be simultaneous biaxial stretching or sequential biaxial stretching.

The temperature when biaxially stretching the raw film may be (Tg+5° C.) or higher and (Tg+20° C.) or lower, (Tg+6° C.) or higher and (Tg+18° C.) or lower, or (Tg+7° C.) or higher and (Tg+15° C.) or lower, where the glass transition temperature of the acrylic resin composition is Tg. The surface magnification when biaxially stretching the raw film is not particularly limited, but is, for example, 2 times or more and 10 times or less. The stretching speed when biaxially stretching the raw film is not particularly limited, but is, for example, 1.1 times/min or more and 100 times/min or less. When sequentially biaxially stretching the raw film, the stretching speed of the first step and the stretching speed of the second step may be the same or different. In the sequential biaxial stretching, the stretching in the first step is generally stretching in the longitudinal direction (MD direction), and the stretching in the second step is stretching in the width direction (TD direction).

Although one or more embodiments of the present invention have been described above, the present invention is not limited to the above-described embodiments, and the above-described embodiments may be appropriately modified within the scope of the gist of the present invention.

### EXAMPLES

Hereinafter, Examples of the present invention will be described, but the present invention is not limited to the Examples.

(Content of Constitutional Unit containing Glutarimide Ring in Main Chain)

¹H-NMR spectrum of an acrylic resin was measured using a nuclear magnetic resonance apparatus Avance III (manufactured by BRUKER) having a proton resonance frequency of 400 MHZ. A molar ratio of the constitutional unit derived from methyl methacrylate to the constitutional unit containing a glutarimide ring in the main chain was converted into a weight ratio, and the content of the constitutional unit containing a glutarimide ring in the main chain was calculated. At this time, the molar ratio was determined from peak area A derived from the O—CH₃ protons of methyl methacrylate around 3.5 to 3.8 ppm and peak area B derived from the N—CH₃ protons of glutarimide around 3.0 to 3.3 ppm.

### (Glass Transition Temperature)

Using a high-sensitivity differential scanning calorimeter DSC7000X (manufactured by Hitachi High-Technologies Corporation), 10 mg of an acrylic resin or acrylic resin composition was heated at a heating rate of 10° C./min in a nitrogen atmosphere, and the glass transition temperature was determined by a midpoint method.

### (1% Weight Reduction Temperature)

10 mg of the acrylic resin composition was heated from room temperature at a heating rate of 10° C./min in a nitrogen atmosphere using a simultaneous differential thermogravimetric analyzer STA7200 (manufactured by Hitachi High-Technologies Corporation), and a 1% weight reduction temperature was determined.

(Birefringence Developability Δnxy)

A range of 30×100 mm was cut out from a raw film, and then the film was subjected to end-free uniaxial stretching at a temperature higher than the glass transition temperature of the raw film by 5° C. so that the stretching ratio in the longitudinal direction (lengthwise direction) was 2 to obtain a uniaxially stretched film. Next, the in-plane retardation of the central portion of the uniaxially stretched film was measured using a retardation measuring apparatus KOBRA-WR (manufactured by Oji Scientific Instruments), and then was divided by the thickness of the uniaxially stretched film to obtain the birefringence developability Δnxy.

### (Thickness Direction Retardation Rth)

The thickness direction retardation Rth of the polarizer protective film at a wavelength of 590 nm was measured using a retardation measuring apparatus KOBRA-WR (manufactured by Oji Scientific Instruments).

### (Average Value and Standard Deviation of In-Plane Retardation Re)

A range of 150×150 mm at the center was cut out from the polarizer protective film, and then the average value and standard deviation of the in-plane retardations Re were measured using a two-dimensional birefringence evaluation system WPA-200 (manufactured by Photonic Lattice, Inc.). At this time, after three lines were drawn in each of the MD direction and the TD direction, an average value and a standard deviation of the in-plane retardations Re were obtained by the line analysis function.

### (Yellowness Index)

The polarizer protective film was cut into a 3 cm square, and a yellowness index (YI) was measured using a color meter SC-P (manufactured by Suga Test Instruments Co., Ltd.) in accordance with JIS K7373:2006.

### (Absorbance at Wavelength 380 nm)

The absorbance of the polarizer protective film at a wavelength of 380 nm was measured using an ultraviolet-visible near-infrared spectrophotometer UV-560 (manufactured by JASCO Corporation).

### (Photoelastic Coefficient)

The photoelastic coefficient of the polarizer protective film was measured using a retardation measuring apparatus KOBRA (manufactured by Oji Scientific Instruments). Specifically, the polarizer protective film was cut into 15 mm×60 mm and a tensile load was applied to the obtained piece of film, varying from 0 g to 1100 g in increments of 100 g, and the resulting changes in retardations were measured. A graph was created by plotting the stress calculated from the tensile load value on the X-axis, and the birefringence calculated from the measured value of the retardation and the film thickness on the Y-axis, and the slope of a straight line was calculated to obtain the photoelastic coefficient.

(Yellowness Index When Viewed from Oblique Direction of Liquid Crystal Panel)

The liquid crystal panel was simulated using a liquid crystal simulator LCD Master (manufactured by Thing-tech). At this time, a polarizing plate disposed on the light source side, an IPS type liquid crystal cell having an in-plane retardation Re of 295 nm, and a polarizing plate disposed on the viewing side were disposed in this order. The measurement result of the thickness direction retardation Rth was input as the optical characteristic of the polarizer protective films of the polarizing plates disposed on the light source side and the viewing side so as to face the liquid crystal cell. Next, the liquid crystal cell was set to a dark state and a value of XYZ color system when viewed from a polar angle of 70° and an azimuthal angle of 40° was obtained by simulation, and a yellowness index (YI) was obtained from the following formula in accordance with JIS K7373:2006. YI=100(1.2985X-1.1335Z)/Y

### (Rth(447)/Rth(548), Rth(628)/Rth(548), and Nz Coefficient)

Using a retardation measuring apparatus KOBRA-WR (manufactured by Oji Scientific Instruments), the retardations at the wavelength λ of the polarizer protective film (λ=446.7 nm, 547.9 nm, and 628.2 nm) were measured. Specifically, the in-plane retardation Re(λ) at each wavelength and the retardation R⁴⁰(λ) measured by inclining the absorption axis as an inclination axis by 40° were measured, and then the three-dimensional refractive indices nx(λ), ny(λ), and nz(λ) at each wavelength were calculated using three-dimensional refractive index calculation software N-Calc (manufactured by Oji Scientific Instruments). Next, using the three-dimensional refractive indices nx(λ), ny(λ), and nz(λ), and the following formula:

$$Rth ( λ ) = [ \{ n x ( λ ) + ny ( λ ) \} / 2 - nz ( λ ) ] \times d ,$$

the thickness direction retardation Rth (A) at each wavelength was calculated, and the wavelength dispersion characteristics Rth(447)/Rth(548) and Rth(628)/Rth(548) were obtained. In addition, by using the in-plane retardation Re (548) and the thickness direction retardation Rth(548) at a wavelength of 548 nm, and the following formula:

$$Nz coefficient = \{ Rth ( 548 ) / R e ( 5 \; 48 ) ] + 0.5 ,$$

the Nz coefficient was calculated.

### (Haze and Inner Haze)

The haze of the polarizer protective film was measured using a haze meter NDH 2000 (manufactured by Nippon Denshoku Industries), in accordance with JIS-7136:2000. In addition, the polarizer protective film was placed in a glass cell for liquid measurement, distilled water was brought into contact with both surfaces of the polarizer protective film, and the internal haze of the polarizer protective film was measured.

### (Weight Average Molecular Weight, Number Average Molecular Weight and Dispersity)

The weight average molecular weight (Mw), number average molecular weight (Mn) and dispersity (Mw/Mn) of the acrylic resin composition were calculated using gel permeation chromatography (GPC). At this time, an analysis was performed under the following conditions using a sample solution prepared by dissolving 20 mg of an acrylic resin composition in 10 mL of tetrahydrofuran.
Measuring instrument: HLC-8420GPC (manufactured by Tosoh)
Detector: RI detector
Eluent: tetrahydrofuran
Guard column: TSK gel guard column Super H-L (manufactured by Tosoh)
Analysis column: TSK gel Super H5000, Super H4000, Super H3000, and Super H2000 (from Tosoh) (in series)
Eluent flow rate: 0.6 mL/min
Measurement temperature: 40° C.
Standard substance: standard polystyrene (manufactured by Tosoh)

### (Production of Acrylic Resin 1)

In an intermeshing co-rotating twin-screw extruder (L/D=90) having a bore diameter of 40 mm equipped with a die at the outlet, the set temperature and screw rotation speed of each temperature control zone thereof was set to 250 to 280° C. and 85 rpm, respectively, and methyl methacrylate resin parapet HM (manufactured by Kuraray) was melted by a kneading block to fill the kneading block. Next, 1.8% by weight of monomethylamine (manufactured by Mitsubishi Gas Chemical Co., Ltd.) was added to the methyl methacrylate resin through a nozzle to imidize the methyl methacrylate resin. Next, the strand extruded from the die was cooled using a water bath, and then pelletized using a pelletizer to obtain a resin (I).

In an intermeshing co-rotating twin-screw extruder (L/D=90) having a bore diameter of 40 mm equipped with a die at the outlet, the set temperature and screw rotation speed of each temperature control zone thereof was set to 240 to 260° C. and 85 rpm, respectively, and the resin (I) was melted by a kneading block to fill the kneading block. Next, 0.56% by weight of dimethyl carbonate was added to the resin (I) through a nozzle to esterify the carboxyl group in the resin (I). At this time, by-products and excess dimethyl carbonate after the reaction were removed. Next, the strand extruded from the die was cooled using a water bath, and then the strand was pelletized using a pelletizer to obtain an acrylic resin 1. The acrylic resin 1 had a glass transition temperature of 123° C. and a content of the constitutional unit containing a glutarimide ring in the main chain of 6% by weight.

### (Production of Acrylic Resin 2)

Acrylic resin 2 was obtained in the same manner as in acrylic resin 1 except that the added amount of monomethylamine was changed to 4.3% by weight with respect to the methyl methacrylate resin. The acrylic resin 2 had a glass transition temperature of 125° C. and a content of the constitutional unit containing a glutarimide ring in the main chain of 15% by weight.

### (Production of Acrylic Resin 3)

Acrylic resin 3 was obtained in the same manner as acrylic resin 1 except that methyl methacrylate-styrene copolymer TX-100 (manufactured by Denka Company Limited) in which the content of the constitutional unit derived from styrene was 40% by weight was used instead of the methyl methacrylate resin, and the added amount of monomethylamine was 8.2% by weight with respect to the methyl methacrylate-styrene copolymer. The acrylic resin 5 had a glass transition temperature of 125° C. and a content of constituent units containing a glutarimide ring in the main chain of 45% by weight.

Table 1 shows the characteristics of the acrylic resins.

TABLE 1

| | | Content of constitutional | |
|---|---|---|---|
| | Glass transition | unit containing glutarimide | Constitutional |
| Acrylic | temperature | ring in main chain | unit derived |
| resin | [° C.] | [% by weight] | from styrene |
| 1 | 123 | 6 | Absent |
| 2 | 125 | 15 | Absent |
| 3 | 125 | 45 | Present |

### Example 1

95% by weight of acrylic resin 1 and 5% by weight of a methyl methacrylate-styrene copolymer KT-89 (manufactured by Denka Company Limited) containing 11% by weight of a constitutional unit derived from styrene were kneaded using an intermeshing co-rotating twin-screw extruder (L/D=45) having a bore diameter of 15 mm equipped with a die at the outlet. Next, the strand extruded from the die provided at the outlet of the extruder was cooled using a water bath, and then the strand was pelletized using a pelletizer to obtain an acrylic resin composition. The acrylic resin composition had a glass transition temperature of 123° C., a 1% weight reduction temperature of 308° C., a Mw of 81,000, and a Mw/Mn of 1.62.

After the acrylic resin composition was dried at 100° C. for 5 hours, the acrylic resin composition was melted using an intermeshing co-rotating twin-screw extruder (L/D=45) having a T-die at the outlet and a bore diameter of 15 mm. Next, the sheet extruded from the T die was cooled using a cooling roll to obtain a raw film having a width of 160 mm and a thickness of 160 μm.

Using a film biaxial stretching apparatus IMC-1905 (manufactured by Imoto Machinery), the raw film was simultaneously biaxially stretched at a temperature 15° C. higher than the glass transition temperature of the acrylic resin composition so that both the stretching ratio in the longitudinal direction and the lateral direction were 2 to obtain a polarizer protective film of 280 mm×280 mm. At this time, the haze and the inner haze of the polarizer protective film were 0.100% and 0.100%, respectively.

### Example 2

A polarizer protective film was obtained in the same manner as in Example 1, except that the ratio of the acrylic resin 1 and KT-89 (manufactured by Denka Company, Limited) to be mixed was changed to 90% by weight and 10% by weight. At this time, the acrylic resin composition had a glass transition temperature of 123° C., a 1% weight reduction temperature of 308° C., a Mw of 81,000, and a Mw/Mn of 1.62. The haze and the inner haze of the polarizer protective film were 0.200% and 0.100%, respectively.

### Example 3

A polarizer protective film was obtained in the same manner as in Example 2 except that the raw film was simultaneously biaxially stretched at a temperature 7° C. higher than the glass transition temperature of the acrylic resin composition. At this time, the haze and the inner haze of the polarizer protective film were 0.200% and 0.100%, respectively.

### Example 4

A polarizer protective film was obtained in the same manner as in Example 2 except that a methyl methacrylate-styrene copolymer MS-750 (manufactured by Toyo Styrene Co., Ltd.) in which the content of a constitutional unit derived from styrene was 25% by weight was used instead of KT-89 (manufactured by Denka Company Limited), and the raw film was simultaneously biaxially stretched at a temperature 10° C. higher than the glass transition temperature of the acrylic resin composition. At this time, the acrylic resin composition had a glass transition temperature of 122° C., a 1% weight reduction temperature of 306° C., a Mw of 76,000, and a Mw/Mn of 1.59. The haze and the inner haze of the polarizer protective film were 0.100% and 0.100%, respectively.

### Example 5

A polarizer protective film was obtained in the same manner as in Example 4 except that 10% by weight of methyl methacrylate resin parapet HM (manufactured by Kuraray) was added instead of KT-89 (manufactured by Denka Company Limited). At this time, the acrylic resin composition had a glass transition temperature of 120° C., a 1% weight reduction temperature of 302° C., a Mw of 81,000, and a Mw/Mn of 1.59. The haze and the inner haze of the polarizer protective film were 0.100% and 0.100%, respectively.

### Comparative Example 1

A polarizer protective film was obtained in the same manner as in Example 1 except that KT-89 (manufactured by Denka Company Limited) was not used. At this time, the acrylic resin composition had a glass transition temperature of 123° C. and a 1% weight reduction temperature of 310° C. The haze and the inner haze of the polarizer protective film were 0.100% and 0.100%, respectively.

### Comparative Example 2

A polarizer protective film was obtained in the same manner as in Comparative Example 1 except that the acrylic resin 2 was used instead of the acrylic resin 1. At this time, the acrylic resin composition had a glass transition temperature of 125° C. and a 1% weight reduction temperature of 315° C. The haze and the inner haze of the polarizer protective film were 0.200% and 0.100%, respectively.

### Comparative Example 3

A polarizer protective film was obtained in the same manner as in Example 1 except that the acrylic resin 1 was not used and the raw film was simultaneously biaxially stretched at a temperature 20° C. higher than the glass transition temperature of the acrylic resin composition. At this time, the acrylic resin composition had a glass transition temperature of 117° C. and a 1% weight reduction temperature of 297° C. The haze and the inner haze of the polarizer protective film were 0.200% and 0.100%, respectively.

### Comparative Example 4

A polarizer protective film was obtained in the same manner as in Comparative Example 3, except that a methyl methacrylate-styrene copolymer MS800 (manufactured by Nippon Steel Chemical) in which the content of a constitutional unit derived from styrene was 20% by weight was used instead of KT-89 (manufactured by Denka Company Limited), and the raw film was simultaneously biaxially stretched at a temperature 30° C. higher than the glass transition temperature of the acrylic resin composition. At this time, the acrylic resin composition had a glass transition temperature of 115° C. and a 1% weight reduction temperature of 296° C. The haze and the inner haze of the polarizer protective film were 0.100% and 0.100%, respectively.

### Comparative Example 5

A polarizer protective film was obtained in the same manner as in Comparative Example 1 except that the acrylic resin 3 was used instead of the acrylic resin 1 and the raw film was simultaneously biaxially stretched at a temperature 35° C. higher than the glass transition temperature of the acrylic resin composition. At this time, the acrylic resin composition had a glass transition temperature of 125° C. and a 1% weight reduction temperature of 320° C. The haze and the inner haze of the polarizer protective film were 0.200% and 0.100%, respectively.

Table 2 shows the characteristics and evaluation results of the acrylic resin compositions and the polarizer protective films.

TABLE 2

| | Example | | | | | Comparative Example | | | | |
|---|---|---|---|---|---|---|---|---|---|---|
| | 1 | 2 | 3 | 4 | 5 | 1 | 2 | 3 | 4 | 5 |
| Acrylic resin | 1 | 1 | 1 | 1 | 1 | 1 | 2 | — | — | 3 |
| Content of constitutional | 0.6 | 1.1 | 1.1 | 2.5 | 0 | 0 | 0 | 11 | 20 | 40 |
| unit derived from styrene | | | | | | | | | | |
| [% by weight] | | | | | | | | | | |
| Glass transition | 123 | 123 | 123 | 122 | 120 | 123 | 125 | 117 | 115 | 125 |
| temperature Tg of acrylic | | | | | | | | | | |
| resin composition [° C.] | | | | | | | | | | |
| 1% weight reduction | 308 | 308 | 308 | 306 | 302 | 310 | 315 | 297 | 296 | 320 |
| temperature of acrylic resin | | | | | | | | | | |
| composition [° C.] | | | | | | | | | | |
| Δ nxy [×10⁻³] | −0.14 | −0.14 | −0.14 | −0.31 | −0.20 | 0.0 | 0.40 | −1.3 | −2.5 | −3.3 |
| Temperature of | Tg + 15 | Tg + 15 | Tg + 7 | Tg + 10 | Tg + 10 | Tg + 15 | Tg + 15 | Tg + 20 | Tg + 30 | Tg + 35 |
| simultaneous biaxial | | | | | | | | | | |
| stretching[° C.] | | | | | | | | | | |
| Rth [nm] | −2.5 | −5.1 | −7.5 | −10.0 | −6.0 | 0.0 | 10.2 | −10.0 | −10.5 | −11.0 |
| Average value of Re [nm] | 0.5 | 0.5 | 0.4 | 0.6 | 0.2 | 0.2 | 0.2 | 0.8 | 0.9 | 1.0 |
| Standard deviation of Re | 0.1 | 0.1 | 0.1 | 0.1 | 0.1 | 0.1 | 0.2 | 0.4 | 0.4 | 0.4 |
| YI | 0.21 | 0.22 | 0.22 | 0.30 | 0.14 | 0.28 | 0.32 | 0.31 | 0.37 | 0.5 |
| Absorbance at a | 0.04 | 0.041 | 0.042 | 0.042 | 0.04 | 0.042 | 0.043 | 0.044 | 0.045 | 0.048 |
| wavelength of 380 nm | | | | | | | | | | |
| Photoelastic coefficient | −3.2 | −3.1 | −3 | −4.0 | −5.0 | −2.9 | −2.2 | −2.9 | −2.1 | 2.1 |
| [10⁻¹²Pa⁻¹] | | | | | | | | | | |
| Nz coefficient | −4.5 | −9.7 | −18.3 | −16.2 | −29.5 | 0.5 | 51.5 | −12.0 | −11.2 | −10.5 |
| Rth(447)/Rth (548) | 1.000 | 1.000 | 1.000 | 0.900 | 1.000 | 0.958 | 1.100 | 1.100 | 1.100 | 1.100 |
| Rth(628)/Rth(548) | 1.020 | 1.000 | 1.000 | 1.356 | 1.200 | 1.000 | 1.200 | 1.000 | 1.000 | 1.000 |
| YI when viewed from | 47 | 43 | 39 | 35 | 42 | 52 | 66 | 36 | 35 | 34 |
| oblique direction of liquid | | | | | | | | | | |
| crystal panel | | | | | | | | | | |

From Table 2, it can be seen that the polarizer protective films of Examples 1 to 5 achieved both the standard deviation of Re and the reduction of YI when viewed from an oblique direction of the liquid crystal panel. On the other hand, in the polarizer protective film of Comparative Example 1, since Δnxy was 0.0 and Rth was 0.0 nm, YI was large when viewed from an oblique direction of the liquid crystal panel. In the polarizer protective film of Comparative Example 2, since Δnxy was 4.0×10⁻⁴ and Rth was 10.2 nm, YI was large when viewed from an oblique direction of the liquid crystal panel. In the polarizer protective films of Comparative Examples 3 to 5, since Δnxy values were −1.3×10⁻³, −2.5×10⁻³, and −3.3×10⁻³, respectively, the standard deviations of Re were large.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A polarizer protective film comprising an acrylic resin composition, wherein:
a thickness direction retardation Rth at a wavelength of 590 nm is −15.0 nm or more and less than 0.0 nm; and
the acrylic resin composition:
comprises an acrylic resin having a ring structure in a main chain,
has a glass transition temperature of 120° C. or higher, and
has a birefringence developability Δnxy of −1.0×10⁻³ or more and −0.1×10⁻³ or less.

2. The polarizer protective film according to claim 1, wherein the acrylic resin has a constitutional unit comprising at least one ring structure selected from the group consisting of a glutarimide ring, a lactone ring, a maleic anhydride ring, a maleimide ring, and a glutaric anhydride ring in the main chain.

3. The polarizer protective film according to claim 2, wherein the acrylic resin has a constitutional unit represented by the formula (1): 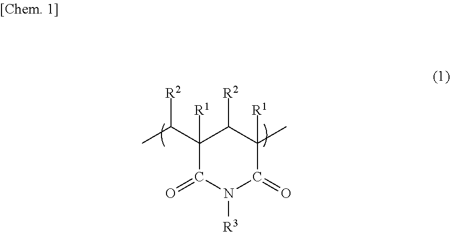
wherein R¹ and R² are each independently a hydrogen atom or an alkyl group having 1 or more and 8 or less carbon atoms, and R³ is a hydrogen atom, an alkyl group having 1 or more and 18 or less carbon atoms, or a cycloalkyl group having 3 or more and 12 or less carbon atoms.

4. The polarizer protective film according to claim 1, wherein a content of a constitutional unit derived from aromatic vinyl is 0% by weight or more and 8% by weight or less.

5. The polarizer protective film according to claim 4, wherein a content of a constitutional unit derived from styrene is 0% by weight or more and 8% by weight or less.

6. The polarizer protective film according to claim 1, wherein the acrylic resin composition further comprises poly methyl methacrylate or a methyl methacrylate-styrene copolymer.

7. The polarizer protective film according to claim 1, wherein the acrylic resin composition has a 1% weight reduction temperature of 300° C. or higher.

8. The polarizer protective film according to claim 1, wherein the polarizer protective film does not contain an ultraviolet absorber.

9. The polarizer protective film according to claim 1, wherein the polarizer protective film is a biaxially stretched film.

10. The polarizer protective film according to claim 1, wherein a yellowness index is 0.01 or more and 5.00 or less.

11. The polarizer protective film according to claim 1, wherein an absorbance at a wavelength of 380 nm is 0.01 or more and 1.00 or less.

12. The polarizer protective film according to claim 1, wherein:
an absolute value of an Nz coefficient is 0.1 or more and 30.0 or less;
a ratio Rth(447)/Rth(548) of a thickness direction retardation Rth(447) at a wavelength of 447 nm to a thickness direction retardation Rth(548) at a wavelength of 548 nm is 0.50 or more and 1.10 or less; and
a ratio Rth(628)/Rth(548) of a thickness direction retardation Rth(628) at a wavelength of 628 nm to a thickness direction retardation Rth(548) at a wavelength of 548 nm is 0.50 or more and 2.00 or less.

13. The polarizer protective film according to claim 1, wherein the acrylic resin composition comprises, as a main component, the acrylic resin having the ring structure in the main chain.

14. The polarizer protective film according to claim 1, wherein the acrylic resin composition is free of core-shell rubber particles.

15. The polarizer protective film according to claim 1, wherein an internal haze is 1.0% or less.

16. A polarizer protective film comprising an acrylic resin composition, wherein:
an average value of in-plane retardations Re is more than 0.0 nm and 0.7 nm or less;
a thickness-direction retardation Rth at wavelength 590 nm is −15.0 nm or more and less than 0.0 nm; and
the acrylic resin composition comprises an acrylic resin having a ring structure in a main chain, and a glass transition temperature is 120° C. or higher.

17. The polarizer protective film according to claim 16, wherein the thickness-direction retardation Rth at a wavelength 590 nm is −13.0 nm or more and less than −2.5 nm.

18. A polarizer protective film comprising an acrylic resin composition, wherein:
the acrylic resin composition comprises an acrylic resin having a ring structure in a main chain, a glass transition temperature is 120° C. or higher; and
a thickness direction retardation Rth at a wavelength 590 nm is −15.0 nm or more and less than 0.0 nm, and a standard deviation of in-plane retardations Re is less than 0.2.

19. A polarizing plate comprising the polarizer protective film according to claim 1.

20. A liquid crystal panel comprising the polarizing plate according to claim 19.
